(19) United States
(12) Patent Application Publication
(10) Pub. No.: US 2003/0085239 A1
(43) Pub. Date: May 8, 2003

(54) Chemical feeder

(76) Inventors: Jason Crain, Duluth, GA (US); Michael Scott Newton, Peachtree City, GA (US)

Correspondence Address: Woodard, Emhardt, Naughton,, Moriarty and McNett, Bank One Center/Tower, 111 Monument Circle, Suite 3700, Indianapolis, IN, 46204-5137, US

(21) Appl. No.: 10/213,844

(22) Filed: Aug. 7, 2002

Related U.S. Application Data
(60) Provisional application No. 60/310,682, filed on Aug. 7, 2001.

(51) Int. Cl. B67D 5/08

(52) U.S. Cl. 222/52

(57) ABSTRACT

A feeder for dispensing solid water treatment chemicals into a circulating water system comprises a hopper for holding the solid water treatment chemicals, a housing for holding the hopper and for directing and containing the water to be treated, a water inlet and a water outlet. The hopper has a perforated floor that is separated into a water inlet portion and a water outlet portion. The water inlet feeds water through the water inlet portion where it contacts the water treatment chemicals. The treated water falls by gravity through the water outlet portion of the perforated floor, where it is directed to the water outlet by vacuum pressure. The hopper is removable to facilitate cleaning scale and other insoluble solids form the hopper and the surfaces surrounding it.

The present invention relates generally to feeders for providing water treatment chemicals to a circulating water system such as a swimming pool.

### BACKGROUND OF THE INVENTION

The use of solid oxidizers such as calcium hypochlorite to sanitize circulating water systems such as swimming pools and/or spas is well known to the art. In one common method of using such oxidizers, the solid material is contained in a feeder that is plumbed into the water line so that the material can be dosed to the water at appropriate levels over long periods of time.

The solid oxidizer compositions typically include non-soluble material which can build-up as scale, etc., on the surfaces of the chemical feeder. This scale may clog the feeder or otherwise lead to its inefficient operation.

A need therefore exists for a chemical feeder for providing strong solid oxidizers such as calcium hypochlorite to recirculating water systems, wherein the feeder can easily be cleaned to remove scale and other insoluble material. The present invention addresses that need.

### SUMMARY OF THE INVENTION

The present invention provides a feeder for dispensing solid water treatment chemicals into a circulating water system. The feeder preferably comprises a hopper for holding the solid water treatment chemicals, a housing for holding the hopper and for directing and containing the water to be treated, a water inlet and a water outlet. The hopper has a perforated floor that is separated into a water inlet portion and a water outlet portion. The water inlet feeds water through a water inflow chamber to the bottom of the removable hopper, where it contacts the water treatment chemicals. The treated water then flows out of the hopper through the water outlet portion of the perforated floor, where it falls into a treated water collection chamber before exiting the feeder through a water outlet.

The removable hopper is easily refilled with chemicals when empty, and enables the user to easily clean scale, etc., that builds-up in the feeder.

One object of the present invention is to provide an easy to clean feeder for providing solid chemicals to a circulating water system.

Other objects and advantages will be apparent from the following description.

### BRIEF DESCRIPTION OF THE DRAWINGS

FIG. 1 is a perspective view of one embodiment of the chemical feeder of the present invention, with the removable hopper removed from the housing.

FIG. 2 is a perspective view of one embodiment of the housing portion of the chemical feeder of the present invention, with a removable hopper in the housing.

FIG. 3 is a section view of one embodiment of the housing of the present invention.

FIG. 4 is a section view of one embodiment of the removable hopper of the present invention.

FIG. 5 is a perspective section view of one embodiment of the chemical feeder of the present invention, with the removable hopper present in the housing.

FIG. 6 is an elevational section view of the chemical feeder of FIG. 5.

FIG. 7 is a schematic diagram of the chemical feeder installed in a recirculating water system.

FIG. 8 is a perspective view of one embodiment of the removable hopper of the present invention.

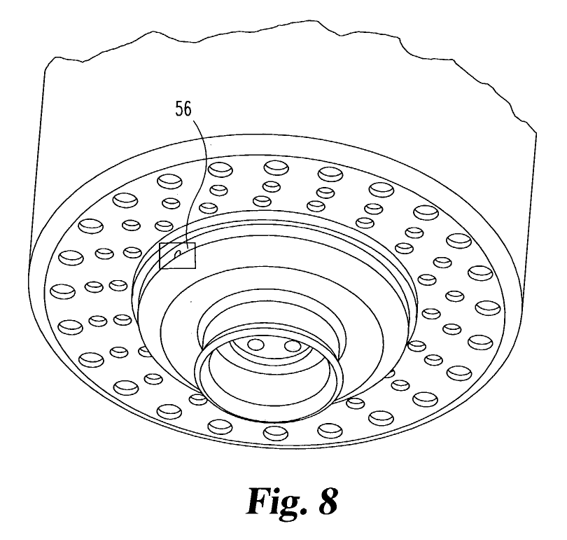

FIG. 9 shows the chemical feeder of the present invention in partial section.

FIG. 10 shows one preferred installation scheme for the chemical feeder of the present invention.

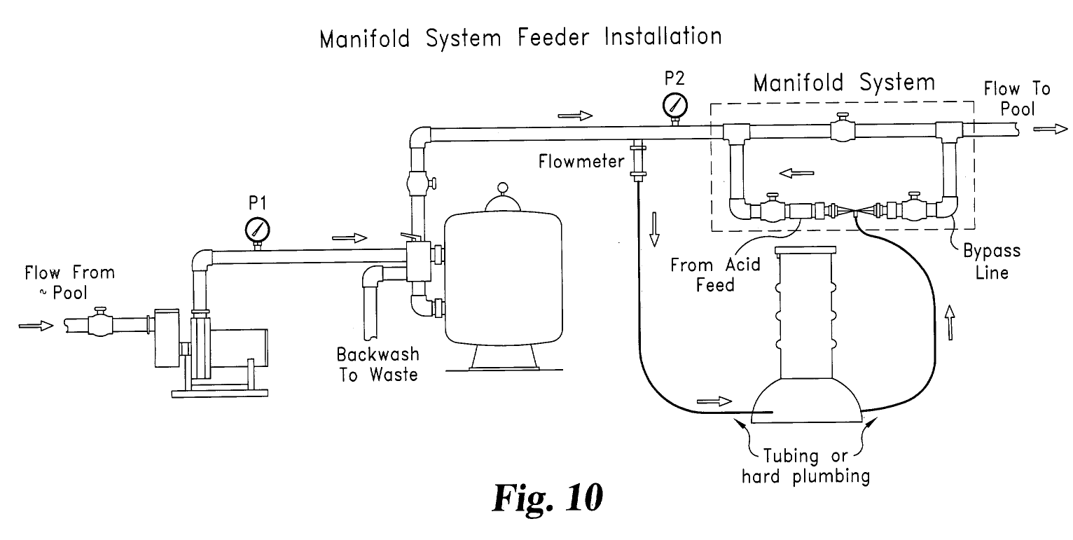

FIG. 11 shows some preferred dimensions for the chemical feeder of the present invention.

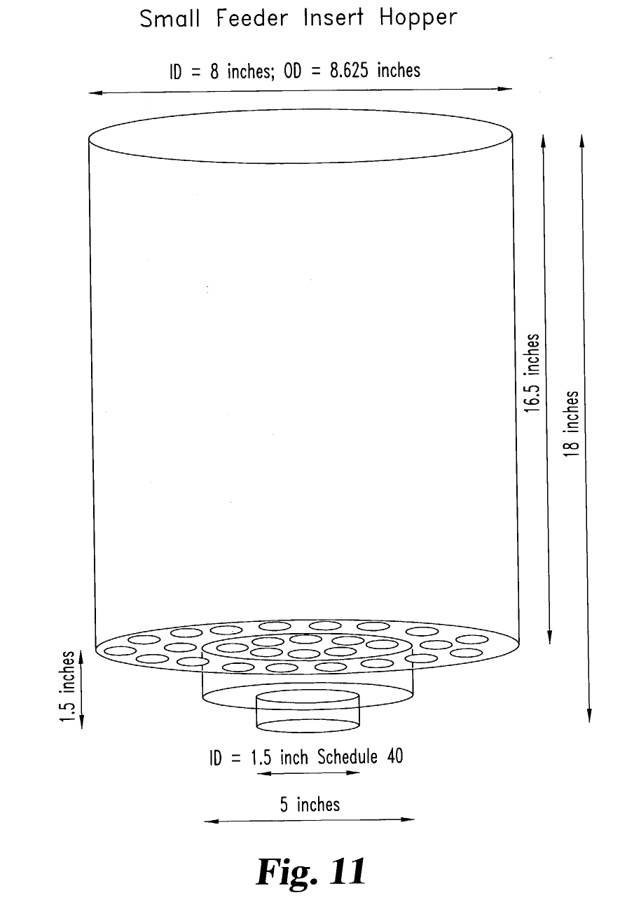

FIG. 12 is a perspective view of one preferred embodiment of the removable hopper of the present invention.

FIG. 13 is a perspective view of the hopper and the housing of one preferred embodiment of the present invention.

### DESCRIPTION OF THE PREFERRED EMBODIMENTS

For the purposes of promoting an understanding of the principles of the invention, reference will now be made to certain preferred embodiments and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

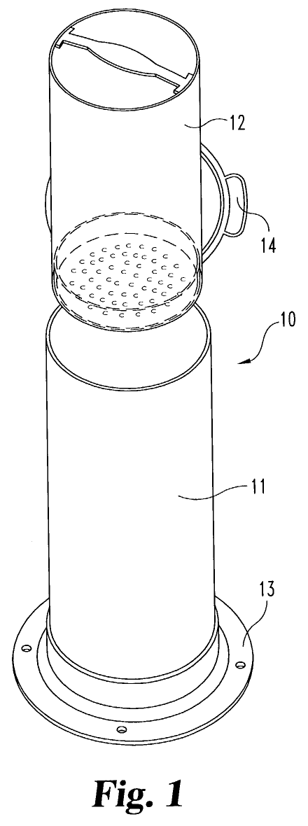

The basic components are shown in FIG. 1. As shown in that figure, feeder 10 preferably includes a housing 11 and a removable hopper 12 with a perforated floor. The housing preferably includes a base portion 13 with water inlets and outlets passing therethrough, and a lid 14 to cover the top of the feeder.

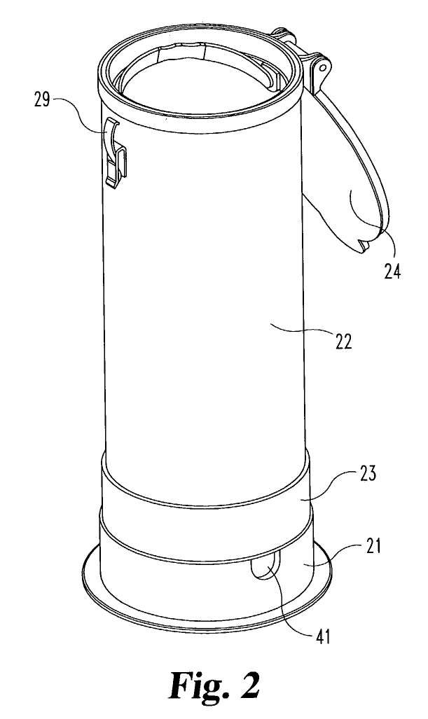

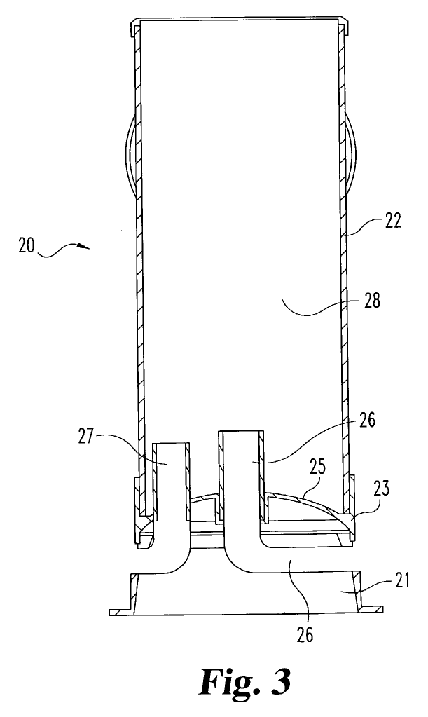

FIGS. 2 and 3 show one preferred embodiment of the housing of the present invention. As shown in those figures, housing 20 preferably includes a base portion 21, sidewalls 22, a base-sidewall connector 23, and a lid 24. Apertures 41 for allowing water inlet 26 and water outlet 27 to pass through the housing are also provided. Water inlet 26 provides untreated water to the feeder, while water outlet 27 passes treated water from the feeder back to the circulating water system.

Lid 24 may be opened to insert or remove the removable hopper, or it may be secured in its closed position with latch 29. When lid 24 is closed, the interior of the housing is relatively airtight, allowing a vacuum to be pulled in the housing to help water flow from water inlet 26 to water outlet 27.

As shown in the section view of FIG. 3, base-sidewall connector 23 cooperates with sidewalls 22 to form a watertight chamber 28 for receiving the removable hopper. Chamber 28 is closed on the bottom and sides (except where the water inlet and water outlet are), but open on the top unless lid 24 is closed. Water inlet 26 and water outlet 27 protrude upward through the floor 25 of base-sidewall connector 23 to provide water into, and out of, the hopper when it is in place. Water outlet 27 is preferably capped with a screen 42 that helps keep pieces of solid material from clogging the water outlet.

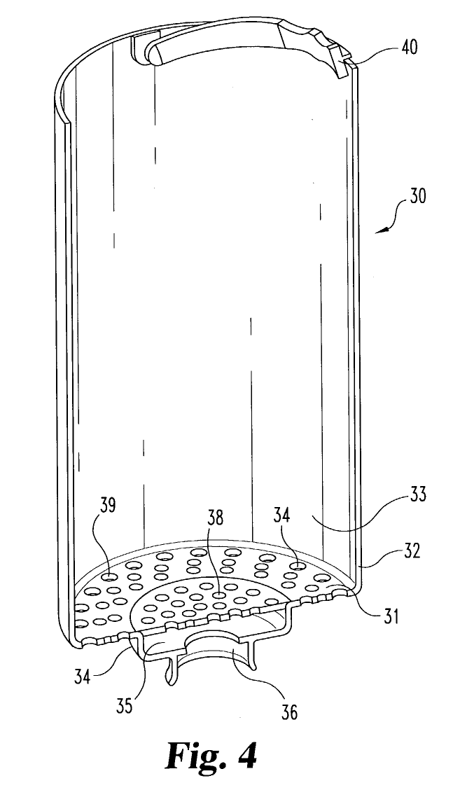

FIG. 4 shows the hopper that is used in the feeder. Removable hopper 30 has a perforated floor 31, with the center portion of the perforated floor having water inlet holes 38, and the outer portion having water outlet holes 39. Sidewalls 32 define a chemical holding chamber 33 above the perforated floor.

A hopper handle 40 is optionally included at the top of the hopper. Preferably the handle can be folded down to the side (as shown in FIGS. 2, 4, 5, and 6) to close the lid. In that folded position the handle also avoids interfering with chemicals being added to the hopper. A stop tab 55 may be included on the handle to contact the top edge of hopper sidewall 32, thereby preventing the handle from being pushed down into the hopper.

Below the perforated floor, sidewalls 34 define a water inflow chamber 35. A connecting member 36 for connecting water inflow chamber 35 with water inlet 26 extends below chamber 35. As previously indicated, perforated floor 31 has water inlet holes 38 above water inflow chamber 35, and water outlet holes 39 outside that region. Water can therefore be directed into chamber 33 by passing through water inlet 26 to water inflow chamber 35, where it then passes through water inlet holes 38 to reach the bottom part of chamber 33. Drain holes 56 are preferably included in sidewalls 34 to allow water to drain from water inflow chamber 35 when water is not flowing through the feeder.

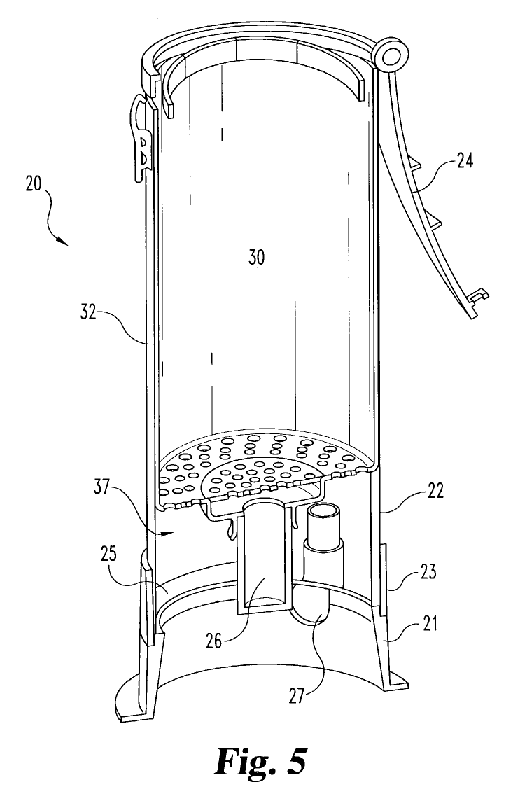

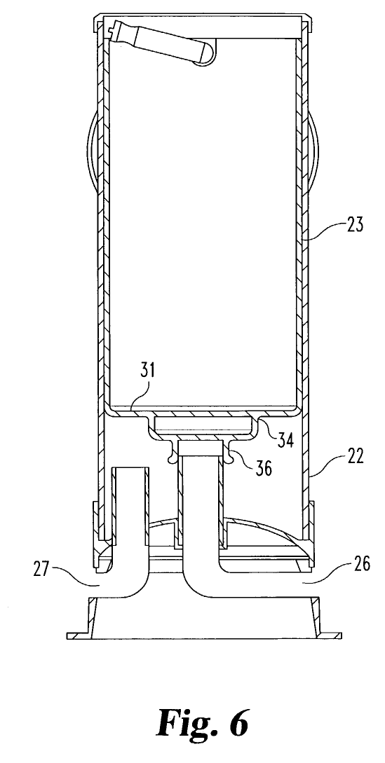

FIGS. 5 and 6 show the assembled feeder, with removable hopper 30 inside housing 20. When hopper 30 is in place, a treated water collection chamber 37 is defined within sidewalls 22 below perforated floor 31 and above floor 25. Treated water collects in this chamber after passing over the chemicals, and is then directed out of the feeder through water outlet 27.

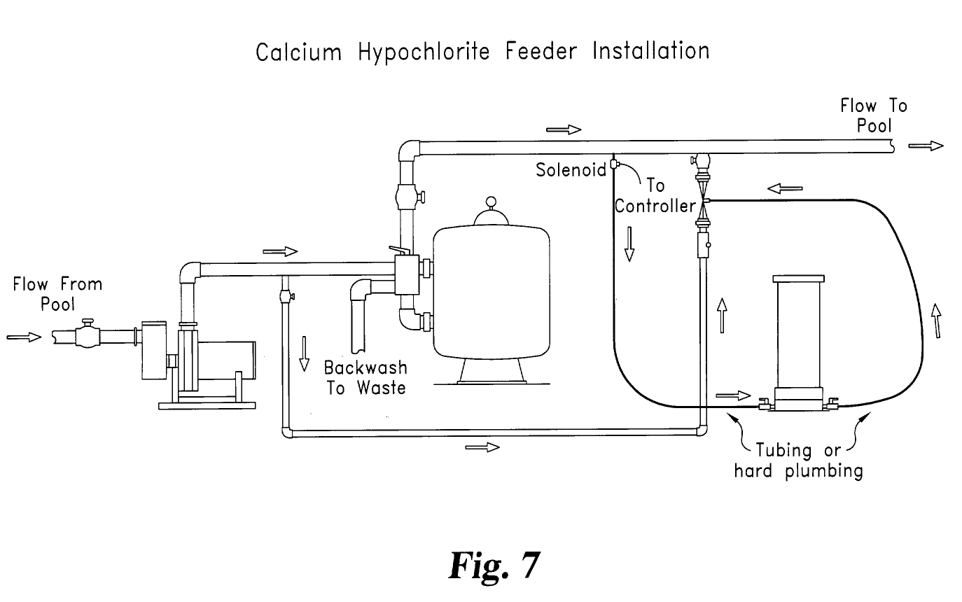

FIG. 7 shows the chemical feeder installed in a recirculating water system. Water is supplied to the unit by tubing or hard plumbing, and may be controlled by a solenoid valve in the water inlet line. The water flows into the feeder and is removed through the water outlet by means of a Venturi injector. The Venturi may use the pressure drop created by the system filter or other means known to those skilled in the art.

In operation, removable hopper 30 is provided with a solid chemical such as calcium hypochlorite. The hopper is placed in the housing so that connector 36 mates with water inlet 26 to provide untreated water to water inflow chamber 35. The untreated water fills water inflow chamber 35 and passes through water inlet holes 38 to enter chemical holding chamber 33. There, it contacts the chemical being provided and becomes treated water. The treated water then passes through water outlet holes 39 before being accumulated in treated water collection chamber 37, where it is returned through water outlet 27 to the water system.

Most preferably a venturi is provided on the water outlet to pull a vacuum in the housing when the lid is closed. This facilitates the flow of water from the water inlet, through the chemical, and back out the water outlet.

In the preferred mode of operation the water inlet and outlet levels are manipulated so that water only contacts the lower surface of the chemicals in the hopper. Preferably, the water level inside the hopper is kept to less than about 1 inch, and more preferably to less than about ½ inch. The physical arrangement of the water inlet, the water outlet, and the hopper facilitates maintaining the water level at this low level. In particular, in the present invention the weir height is equal, or substantially equal, to the height of the bottom of the tablet bed. Accordingly, a standard three-inch diameter water treatment tablet is not completely submerged in the water when the water inflow and water outflow are properly regulated; only the lower portion of the tablet contacts the water.

One advantage of the present invention is that the hopper is easily removable to facilitate cleaning. In prior art feeders, scale and other insoluble solids build up on the surfaces that are exposed to treated water, and particularly in the collection chamber. With the present invention, scale and insolubles can be cleaned from the hopper, and from the surfaces exposed to treated water such as the surfaces of the collection chamber, simply by lifting the hopper out of the housing and washing those surfaces with an acid wash.

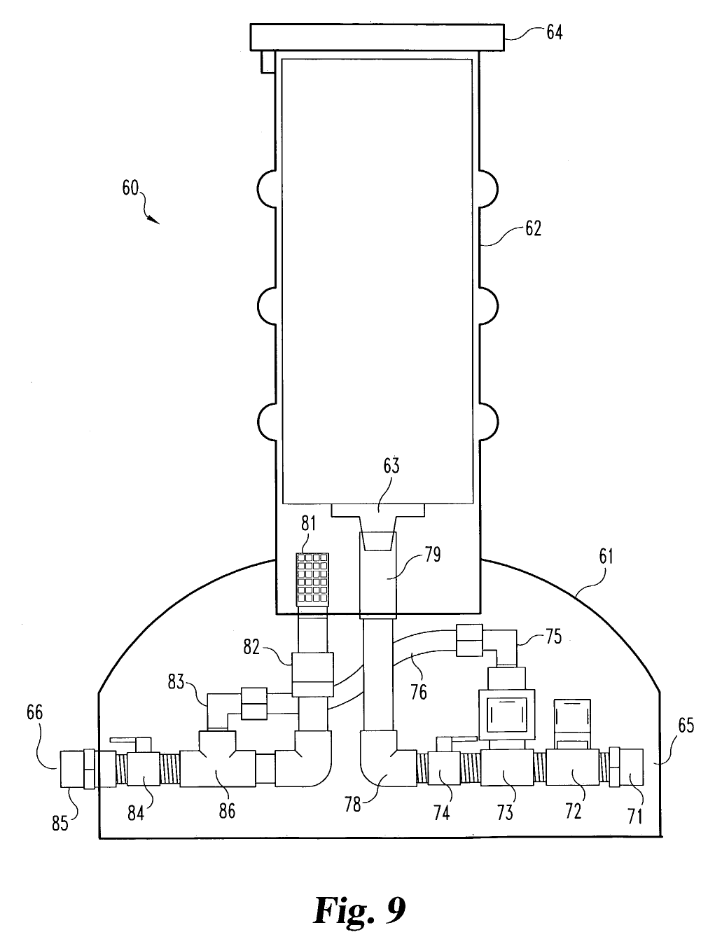

In one preferred embodiment, some features of which are shown in FIG. 9, chemical feeder 60 includes feeder base 61, feeder body 62, and hopper 63. Feeder body 62 closes with lid 64. Inlet line 65 connects through compression fitting 71 with solenoid valve 72 that controls the flow of water through the feeder. Solenoid valve 72 communicates with three-way valve 73, which splits the water inlet line into “treated” and “untreated” streams. The “treated” stream preferably flows through valve 74 and through line 78 to stand pipe 79 before actually being treated. From stand pipe 79 the “treated” stream flows through the lower portion of the hopper where the water is actually treated as described above.

“Untreated” stream flows through fitting 75 and water line (preferably flexible tubing) 76 to three-way connector 86. A check valve 82 is preferably provided in line 76. From three-way connector 86 the untreated water flows through valve 84 to outlet line 66.

The treated water flows to the outlet line 66 through pipe end 81 which is directed to the third pathway of three-way connector 86. From there the treated water exits the feeder through outlet line 66 as shown in the Figure.

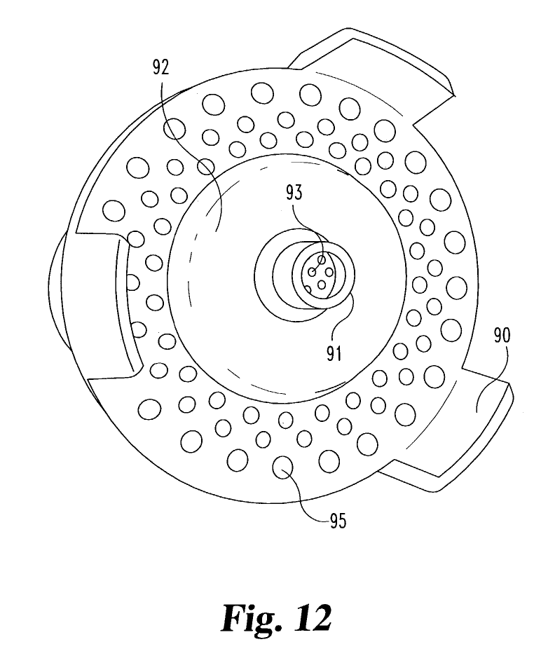

In FIG. 12, the bottom of a removable hopper is shown. Feet 90 hold the hopper above the floor of the housing and position connecting member 91 to receive the water inlet standpipe. Water inflow chamber 92 is in fluid communication with connecting member 91, and facilitates the flow of water through water inlet holes 93. Water outlet holes 95 facilitate the flow of water out of the hopper.

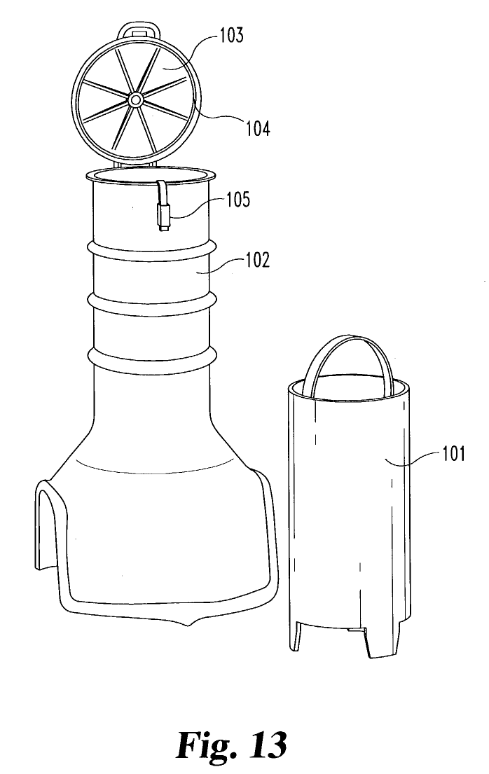

FIG. 13 shows both pieces of one preferred embodiment, including hopper 101 and housing 102. Lid 103 is provided with gasket 104 and latch 105, which combine to allow housing 102 to be substantially airtight when the lid is closed. In that condition a vacuum can be drawn in the housing to facilitate water flow through the feeder.

As indicated above, the feeder of the present invention is particularly easy to clean. For example, when the feeder shown generally in FIG. 9 is provided with the hopper and housing embodiments shown in FIGS. 12 and 13, there is no hopper-support member to block access to the water collection chamber 96. Accordingly, when the removable hopper is removed, water collection chamber 96 and the water inlet and outlet lines are exposed and free of hopper-support members (excluding the end of the water inlet line, which does not substantially support the hopper when the embodiment of FIG. 12 is used), and thus can be washed to remove scale, etc., from the collection chamber and from the water inlet and water outlet lines. This is a significant advantage over the chemical feeders of the prior art.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A feeder for providing a solid chemical composition to a circulating water system, said feeder comprising:
(a) a housing for holding a removable hopper, said housing having an aperture for a water inlet and an aperture for a water outlet;
(b) a water inlet passing through said housing so that untreated water can pass from a circulating water system into the feeder;
(c) a water outlet passing through said housing so that treated water can pass from the feeder back into the circulating water system;
(d) a removable hopper sized to fit in said housing, said hopper comprising:
(i) a perforated floor;
(ii) sidewalls defining a chemical holding chamber above said perforated floor;
(iii) sidewalls defining a water inflow chamber below said perforated floor; and
(iv) a connecting member for connecting said water inflow chamber with said water inlet;
(v) feet extending downwards from said perforated floor to support the hopper in the housing; and
(e) a lid to close the housing.

2. The feeder of claim 1 wherein said removable hopper additionally includes a handle.

3. The feeder of claim 1 wherein said water inlet line divides water into a stream of water to be treated, and a stream of water not to be treated.

4. The feeder of claim 1 wherein said housing defines a water collection chamber when said hopper is positioned in the housing.

5. The feeder of claim 1 wherein said housing is free of hopper-support members when said hopper is removed from the housing.
